(19) United States
(12) Patent Application Publication
(10) Pub. No.: US 2014/0171553 A1
(43) Pub. Date: Jun. 19, 2014

(54) DRY MORTARS WITH LONG OPEN TIME AND INCREASED WATER FACTOR

(71) Applicant: HERCULES INCORPORATED, Wilmington, DE (US)

(72) Inventors: Martin Wunderlich, Langenfeld (DE); Wilfried Adolf Hohn, Erftstadt (DE); Alexander Adolphe Kindler, Ratingen (DE)

(73) Assignee: HERCULES INCORPORATED, Wilmington, DE (US)

(21) Appl. No.: 14/027,815

(22) Filed: Sep. 16, 2013

Related U.S. Application Data
(60) Provisional application No. 61/702,855, filed on Sep. 19, 2012.

(51) Int. Cl. C04B 28/28; C04B 20/00

(52) U.S. Cl. CPC C04B 28/28; C04B 20/00
USPC 524/5; 524/44

(57) ABSTRACT

The presently disclosed and claimed inventive concept(s) relates to a mixture composition for modifying a dry mortar formulation. The mixture composition comprises at least one redispersible polymer powder, a polyamide, a cellulose ether and a multivalent metal salt. The presently disclosed and claimed inventive concept(s) further relates a modified dry mortar formulation, a method of making the modified dry mortar formulation and a method of increasing the open time and water factor of the dry mortar formulation without deteriorating the mechanical strength of the cured dry mortar formulation.

### CROSS REFERENCE TO RELATED APPLICATIONS

The present application claims the benefit under 35 U.S.C. 119 (e) of U.S. Provisional Patent Application Ser. No. 61/702,855, filed Sep. 19, 2012, the entire content of which is hereby expressly incorporated herein by reference.

### BACKGROUND OF THE INVENTION

1. Field of the Presently Disclosed and Claimed Inventive Concept(s)

The presently disclosed and/or claimed inventive process(es), procedure(s), method(s), product(s), result(s), and/or concept(s) (collectively hereinafter referred to as the “presently disclosed and/or claimed inventive concept(s)”) relates generally to a mixture composition for modifying a dry mortar formulation. More particularly, but not by way of limitation, the mixture composition comprises at least one redispersible polymer powder, a polyacrylamide, a cellulose ether, and a multivalent metal salt. The presently disclosed and claimed inventive concept(s) further relates to a modified dry mortar formulation, a method of making the modified dry mortar formulation and a method of increasing the open time and water factor of the dry mortar formulation without deteriorating the mechanical strength of the cured dry mortar formulation.

2. Background and Applicable Aspects of the Presently Disclosed and Claimed Inventive Concept(s)

Traditional cementitious tile adhesives (CTA) are often simple dry mixtures of cement and sand. The dry mixtures are mixed with water to form wet mortars. These traditional wet mortars, per se, have poor fluidity or trowellability. Consequently, the application of these mortars is labor intensive, especially in summer months under hot weather conditions, because of the rapid evaporation or removal of water from the mortars which results in inferior or poor workability as well as short open and correction time and insufficient hydration of cement.

The physical characteristics of a hardened traditional mortar are strongly influenced by its hydration process, and thus, by the rate of water removal therefrom during the setting operation. Any influence, which affects these parameters by increasing the rate of water removal or by diminishing the water concentration in the mortar at the onset of the setting reaction, can cause a deterioration of the physical properties of the mortar. Some ceramic tiles, on their unglazed surfaces, are highly porous and can remove a significant amount of water from the mortar leading to the difficulties just mentioned. Likewise, most substrates to which these tiles are applied, such as lime sandstone, cinderblock, wood or masonry, are also porous and lead to the same problems.

In the dry mortar industry, cellulose ethers are typically used as water retention agents to achieve good water retention of the resulting wet mortar. Water retention is needed to control the water content for proper hydration of the mortar, including any binder, and to achieve good workability of the mortar. Secondary beneficial effects resulting from correct hydration performance of the mortar include less crack formation and proper strength development of the mortar.

Since cellulose ethers alone cannot provide all properties requested by a customer, usually additive blends can be used. These blends are mixtures of different components. They are responsible for the performance of the final cementitious tile adhesive or external thermal insulation composite system (ETICS) mortar. Besides cellulose ethers these blends might contain, for example but not by way of limitation, thickening agents, air entraining agents and dispersants. These so-called modification agents are delivering additional performance.

Polyacrylamides are widely used in cement based dry mortars. They are highly efficient flocculation agents, which enhance mortar viscosity of the resulting wet mortar. As a consequence the water demand of the system increases which can prolong visual open time of the final mortar.

Cement mortars like tile adhesives and ETICS-mortars have to fulfill international standards. Redispersible powders are widely used to enhance strength performance of cement mortars in order to meet these standards.

Redispersible powders, also often called redispersible polymer powders or latex powders, are produced via spray drying of mixtures containing polymer emulsions (e.g. VAC/E, VACNeova, St/Ac etc.), protective colloids (e.g. polyvinyl alcohol) and anti-caking agents (e.g. calcium carbonate, silica etc.). The strong film formation properties of redispersible powders limits visual open time of cement based mortars.

The need exists for a mortar which has excellent visual open time, high strength values, nice workability, and good anti sagging properties.

### DETAILED DESCRIPTION

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description or illustrated in the drawings. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions and/or methods disclosed herein can be made and executed without undue experimentation in light of the present disclosure. While the compositions and methods of the presently disclosed and/or claimed inventive concept(s) have been described in terms of preferred embodiments, it will be apparent to those of ordinary skill in the art that variations may be applied to the compositions and/or methods and in the steps or in the sequence of steps of the method described herein without departing from the concept, spirit and scope of the presently disclosed and/or claimed inventive concept(s). All such similar substitutes and modifications apparent to those skilled in the art are deemed to be within the spirit, scope and concept of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.” Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

Disclosed herein is a mixture composition for modifying a dry mortar formulation. Specifically, the mixture composition comprises or consists of or consists essentially of at least one water-redispersible polymer powder, a polyacrylamide, a cellulose ether, and a multivalent metal salt.

Water-redispersible polymer powders are those which break down into primary particles in water, and then dispersed (“redispersed”) in water. The use of such water-redispersible polymer powders in dry-mix mortars is common and known to improve, depending on the type and addition rate, the adhesion on all kinds of substrates, the deformability of the mortars, the flexural strength and the abrasion resistance, to name only a few of several properties. The polymer powder can comprise one or more compounds of homopolymers and/or copolymers and/or terpolymers of one or monomers selected from the group consisting of vinyl esters of unbranched or branched C₁-C₁₅ alkylcarboxylic acids, (meth)acrylic ester of C₁-C₁₅ alcohols, vinylaromatics, olefins, dienes, and vinyl halogenides.

In one non-limiting embodiment, vinyl esters can be vinyl acetate; vinyl propionate; vinyl butyrate; vinyl 2-ethylhexanoate; vinyl laurate; 1-methylvinyl acetate; vinyl pivalate; vinyl acetate-ethylene copolymers with an ethylene content of from about 1 to about 60% by weight; vinyl ester-ethylene-vinyl chloride copolymers with an ethylene content of from about 1 to about 40% by weight and a vinyl chloride content of from about 20 to about 90% by weight; vinyl acetate copolymers with from about 1 to about 50% by weight of one or more copolymerizable vinyl esters such as vinyl laurate, vinyl pivalate, and vinyl esters of alpha-branched monocarboxylic acids having from about 5 to about 11 carbon atoms, especially Versatic acid vinyl esters, which may also contain from about 1 to about 40% by weight of ethylene; and vinyl acetate-acrylic ester copolymers with from about 1 to about 60% by weight of acrylic ester, especially n-butyl acrylate or 2-ethylhexyl acrylate, and which may also contain from 1 to 40% by weight of ethylene.

If desired, the polymers may also contain from about 0.1 to about 10% by weight, based on the overall weight of the polymer, of functional comonomers. These functional comonomers may include, but are not limited to, ethylenically unsaturated monocarboxylic or dicarboxylic acids such as acrylic acid; ethylenically unsaturated carboxyamides such as (meth)acrylamide; ethylenically unsaturated sulfonic acids and/or their salts such as vinylsulfonic acid; polyethylenically unsaturated comonomers such as divinyl adipate, diallyl maleate, allyl methacrylate and triallyl cyanurate; and/or N-methylol(meth)acrylamides and their ethers, for example their isobutoxy or n-butoxy ethers.

Methacrylic esters or acrylic esters can be, but are not limited to, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, and copolymers of methyl methacrylate with 1,3-butadiene.

Vinylaromatics can be, but are not limited to, styrene, methylstyrene, and vinyltoluene, styrene-butadiene copolymers and styrene-acrylic ester copolymers such as styrene-n-butyl acrylate or styrene-2-ethylhexyl acrylate, each with a styrene content of from about 10 to about 70% by weight.

Vinyl halide can be vinyl chloride. Vinyl chloride polymers can be, but are not limited to, vinyl ester/vinyl chloride/ethylene copolymers, vinyl chloride-ethylene copolymers and vinyl chloride-acrylate copolymers.

In one non-limiting embodiment, olefins can be ethylene and propylene, and dienes can be 1,3-butadiene and isoprene.

The polymers can be prepared in a conventional manner. In one non-limiting embodiment, the polymer can be prepared by an emulsion polymerization process. The dispersions used may be stabilized with emulsifier or else with a protective colloid, an example being polyvinyl alcohol. To prepare the water-redispersible polymer powders, the polymer dispersion obtainable in this way can be dried. Drying may be conducted by means of spray drying, freeze drying, or by coagulation of the dispersion and subsequent fluidized bed drying. The water-redispersible polymer powder may comprise one or more compounds selected from protective colloids and antiblocking agents. EP1498446A1 discloses methods and examples of producing such water-redispersible polymer powders, the entire contents of which is hereby expressly incorporated herein by reference.

The cellulose ether used in the presently disclosed and claimed inventive concept(s) can be alkylcelluloses, hydroxyalkylcelluloses or alkylhydroxyalkylcelluloses, optionally each with two or more different alkyl and/or hydroxyalkyl substituents, or mixtures of two or more of the before mentioned cellulose derivatives.

Alternatively, or additionally, the mixture composition according to the presently disclosed and claimed inventive concept(s) may comprise one or more water-soluble or at least water-swellable polysaccharides including, for example but no way of limitation, pectin, guar gum, guar derivatives like guar ethers, gum arabic, xanthan gum, dextran, cold-water-soluble starch, starch derivatives like starch ethers, chitin, chitosan, xylan, welan gum, succinoglycan gum, diutan gum, scleroglucan gum, gellan gum, mannan, galactan, glucan, alginate, arabinoxylan, cellulose fibers, and combinations thereof.

The following is a list of some examples of cellulose ethers which can be used in context with the presently disclosed and claimed inventive concept(s): hydroxyalkylcelluloses, e.g., hydroxyethylcellulose (HEC), hydroxypropylcellulose (HPC) and hydroxypropylhydroxyethylcellulose (HPHEC); carboxy-alkylcelluloses, e.g., carboxymethylcellulose (CMC); carboxyalkylhydroxyalkylcelluloses, e.g., carboxymethylhydroxyethylcellulose (CMHEC) and carboxymethyl-hydroxypropylcellulose (CMHPC); sulphoalkylcelluloses, e.g., sulphoethylcellulose (SEC) and sulphopropylcellulose (SPC); carboxyalkylsulphoalkylcelluloses, e.g., carboxymethylsulphoethylcellulose (CMSEC) and carboxymethylsulphopropylcellulose (CMSPC); hydroxyalkylsulphoalkylcelluloses, e.g., hydroxyethylsulphoethylcellulose (HESEC), hydroxypropylsulphoethylcellulose (HPSEC) and hydroxyethylhydroxypropylsulphoethylcellulose (HEHPSEC); alkylhydroxyalkylsulphoalkylcelluloses, e.g., methylhydroxyethylsulphoethylcellulose (MHESEC), methylhydroxyethylhydroxpropylsulphoethylcellulose (MHPSEC) and methylhydroxyethylhydroxypropylsulphoethylcellulose (MHEHPSEC); alkylcelluloses, e.g., methylcellulose (MC) and ethylcellulose (EC); binary or ternary alkylhydroxyalkylcellulose, e.g., methylhydroxyethylcellulose (MHEC), ethylhydroxyethylcellulose (EHEC), methylhydroxypropylcellulose (MHPC) and ethylhydroxypropylcellulose (EHPC); ethylmethylhydroxyethylcellulose (EMHEC); ethylmethylhydroxypropylcellulose (EMHPC); alkenylcelluloses and ionic and nonionic alkenylcellulose mixed ethers, e.g., allylcellulose, allylmethylcellulose, allylethylcellulose and carboxy-methylallylcellulose); dialkylaminoalkylcelluloses, e.g., N,N-dimethylaminoethylcellulose and N,N-diethylaminoethylcellulose; dialkylaminoalkylhydroxyalkylcelluloses, e.g., N,N-dimethylaminoethylhydroxyethylcellulose and N,N-dimethylaminoethylhydroxypropylcellulose; aryl- and arylalkyl- and arylhydroxyalkylcelluloses, e.g., benzylcellulose, methylbenzylcelluiose and benzylhydroxyethylcellulose; as well as reaction products of the above-stated cellulose ethers with hydrophobically modified glycidyl ethers, which have alkyl residues with about C₃ to about C₁₅ carbon atoms or arylalkyl residues with about C₇ to about C₁₅ carbon atoms.

In accordance with the presently disclosed and claimed inventive concept(s), the cellulose ether can be MHEC and MHPC, having an aqueous Brookfield solution viscosity of 2,000 to 100,000 mPas, as measured on a Brookfield RVT viscometer at 20° C., 20 rpm, and a concentration of 2 wt % using the appropriate spindle.

The polyacrylamides useful in the presently disclosed and claimed inventive concept(s) are homopolymers of polyacrylamide or copolymers of polyacryalmide with another ethylenically unsaturated monomer. Examples of ethylenically unsaturated monomers can include, but are not limited to, acrylic acid, acrylonitrile and the like.

The polyacrylamides can be varied from slightly to highly anionic. The anionic polyacrylamides can be copolymers from acrylamide and acrylic acid salts. In one non-limiting embodiment, the salts can be sodium salts. The polyacrylamides can be high molecular weight polyacrylamides that are both acidic and anionic.

Examples of polyacrylamides can be, but are not limited to, poly(acrylamide-co-sodium acrylate), poly(acrylamide-co-acrylic acid), poly(acrylamide-co-sodium-acrylamido methylpropanesulfonate), poly(acrylamide-co-acrylamido methylpropanesulfonic acid), and mixtures thereof.

The polyacrylamide polymers used in the presently disclosed and claimed inventive concept(s) can be prepared by free radical polymerization of acrylamide with or without another ethylenically unsaturated comonomer. A chain-terminator along with the choice of polymerization catalyst and polymerization temperature can be used to control the molecular weight of the polyacrylamide polymers. If desired, polyacrylamides can be incorporated into a moist cellulose ether to form a polyacrylamide modified cellulose ether.

Polyacrylamides are highly efficient flocculation agents for salts based on multivalent cations, especially Al³⁺ and Fe³⁺. At the mean time, multivalent salts, especially Al³⁺ and Fe³⁺ can strongly interact with polyacrylamide (PAM) and cement. They can significantly boost efficiency of PAM in a dry mortar system. Charge density and molecular weight of PAM strongly impact strength of flocculation. In one non-limiting embodiment, PAM with anionic charge has charge degree of about 0-60 wt % and 0.5 wt % aqueous solution viscosity of about 500-8000 mPas. Consequence of flocculation with multivalent salts in cement mortars can strongly increase the mortar viscosity.

The multivalent metal salts can be inorganic and/or organic salts. The multivalent cations can be bivalent, trivalent or even higher in cationic charges. Inorganic salts can be inorganic aluminum salts or inorganic iron salts, but are not limited to these metal cations. The aluminum salts can include, but are not limited to, aluminum sulfate, aluminum hydroxide, aluminum hydroxysulfate, aluminum halogens, and aluminum nitrate. The iron salts can include, but are not limited to iron sulfate, iron chloride, iron nitrate, iron phosphate, and iron acetate. The salts based on multivalent cations can be added during a RDP spray drying process or can be post added as physical blends.

In accordance with the presently disclosed and claimed inventive concept(s), the mixture composition may have additional additives of between about 0.1 and about 80 wt %. In one non-limiting embodiment, the amount of the additive(s) can be between about 0.5 and about 30 wt %. The additives used can include, but are not limited to, organic or inorganic thickening agents and/or secondary water retention agents, anti-sag agents, air entraining agents, wetting agents, defoamers, superplasticizers, dispersants, calcium-complexing agents, retarders, accelerators, water repellants, redispersible powders, biopolymers, fibers, calcium chelating agents, fruit acids, and surface active agents.

Other specific examples of the additives can include, but are not limited to, gelatin, polyethylene glycol, casein, lignin sulfonates, naphthalene-sulfonate, sulfonated melamine-formaldehyde condensate, sulfonated naphthalene-formaldehyde condensate, polyacrylates, polycarboxylate ether, polystyrene sulphonates, phosphates, phosphonates, calcium-salts of organic acids having 1 to 4 carbon atoms such as calcium formate, salts of alkanoates, aluminum sulfate, metallic aluminum, bentonite, montmorillonite, sepiolite, polyamide fibers, polypropylene fibers, polyvinyl alcohol, and homo-, co-, or terpolymers based on vinyl acetate, maleic ester, ethylene, styrene, butadiene, vinyl versatate, and acrylic monomers.

While combining RDP containing appropriate multivalent cations with the PAM containing cellulose ethers the resulting cementitious tile adhesive and ETICS-mortar can show clearly improved application characteristics. Mortar viscosity, yield stress (sag resistance), and the resulting water demand can be strongly increased. The much higher water demand of the final mortar prolongs the visual open time significantly. The synergistic interaction of multivalent metal salt modified RDP and PAM-modified cellulose ether combinations can outperform commercially available products with respect to application characteristics, especially open time.

The mixture composition according to the presently disclosed and claimed inventive concept(s) can be prepared by a wide variety of techniques known for one of ordinary skill in the art. Examples can include, but are not limited to, simple dry blending, combining different components during spray drying process, spraying of solutions or melts onto dry materials, co-extrusion, or co-grinding.

The mixture composition according to the presently disclosed and claimed inventive concept(s) can be used in dry mortar formulations, cementitious tile adhesives, cement based renders, water proofing membranes, and mineral coatings for insulation systems like ETICS. The mixture composition can be admixed to the components of a dry mortar formulation when manufacturing the dry mortar formulation.

In accordance with the presently disclosed and claimed inventive concept(s), the dry mortar formulation comprises a fine aggregate material present in the amount of about 20-90 wt %. In one non-limiting embodiment, the amount of the fine aggregate can be about 50-70 wt %. Examples of the fine aggregate material can be, but are not limited to, silica sand, dolomite, limestone, lightweight aggregates (e.g. perlite, expanded polystyrene, hollow glass spheres), rubber crumbs (recycled from car tires), and fly ash. By “fine” is meant that the aggregate materials have particle sizes up to about 2.0 mm, or up to about 1.0 mm.

In accordance with the presently disclosed and claimed inventive concept(s), the modified dry mortar formulation further comprises a hydraulic cement component present in the amount of about 10-80 wt %. In one non-limiting embodiment, the amount of the cement component can be about 20-50 wt %. Examples of the hydraulic cement can include, but are not limited to, Portland cement, Portland-slag cement, Portland-silica fume cement, Portland-pozzolana cement, Portland-burnt shale cement, Portland-limestone cement, Portland-composite cement, blast furnace cement, pozzolana cement, composite cement, and calcium aluminate cement.

In accordance with the presently disclosed and claimed inventive concept(s), the modified dry mortar formulation further comprises a water-redispersible polymer powder present in the amount of about 0.5 to 40 wt %, a polyacrylamide incorporated cellulose ether present in the amount of about 0.05 to 3.5 wt % and a multivalent metal salt present in the amount of about 0.02 to 10.0 wt %

Alternatively, the mixture composition according to the presently disclosed and claimed inventive concept(s) may be added later to a standard dry mortar formulation not initially containing the mixture composition according to the presently disclosed and claimed inventive concept(s). So, the presently disclosed and claimed inventive concept(s) also relates to a modified dry mortar formulation comprising a standard dry mortar formulation, a cellulose ether, a polyacrylamide, at least one redispersible polymer powder, and a multivalent metal salt. If the mixture composition is packaged in one single package unit. Such a single package unit may be sold separately from a standard dry mortar formulation. The standard dry mortar formulation to which the inventive mixture composition may be added comprises at least one cement component. Further ingredients may be added dependent on the intended use as known to the person skilled in the art.

As already mentioned above the modified dry mortar formulation according to the presently disclosed and claimed inventive concept(s) comprises a standard dry mortar formulation and the mixture composition as specified in detail above. In one non-limiting embodiment, the mixture composition can be present in an amount of about 0.3 to about 70%, based on the weight of the modified dry mortar formulation. In another non-limiting embodiment, the mixture composition can be present from about 0.4 to about 30%, based on the weight of the modified dry mortar formulation. In yet another non-limiting embodiment, the modified composition can be from about 0.5 to about 15%, based on the weight of the modified dry mortar formulation.

The modified dry mortar formulation of the presently disclosed and claimed inventive concept(s) can also have in combination therewith at least one mineral binder of hydrated lime, gypsum, pozzolana, blast furnace slag, hydraulically active calcium hydrosilicates and hydraulic lime. The at least one mineral binder can be present in the amount of about 0.1-70 wt %.

The presently disclosed and claimed inventive concept(s) also relates to a method of making a modified dry mortar formulation. The method comprises admixing the mixture composition as specified in detail above to a standard dry mortar formulation. The compounds of the mixture composition can be admixed individually or in combination to the standard dry mortar formulation.

When preparing a modified dry mortar formulation according to the presently disclosed and claimed inventive concept(s) the relative amounts of the mandatory and optional compounds in the mixture composition should be adapted to the total amounts needed in the final modified dry mortar formulation. It is within the knowledge of a person skilled in the art to prepare a mixture composition with appropriate amounts of mandatory and optional compounds in the light of the amounts of the compounds already present in the standard dry mortar formulation. For example, but not by way of limitation, in case the standard dry mortar formulation already comprises cellulose ether additional amounts of cellulose ether(s) need not necessarily be added to the mixture composition according to the presently disclosed and claimed inventive concept(s). The total amounts of the various compounds in the final modified dry mortar formulation should be in appropriate ranges which can be identified by the person skilled in the art based on his/her knowledge and routine tests.

The presently disclosed and claimed inventive concept(s) also provides a method of increasing the open time of a dry mortar formulation without deteriorating the tensile adhesion strength of the dry mortar formulation when cured. The method of increasing the open time comprises the steps of: a) admixing a mixture composition as specified in detail above to a standard dry mortar formulation, wherein the compounds of the mixture composition can be admixed individually or in combination to the standard dry mortar formulation, b) admixing water to the modified dry mortar formulation, and c) processing the water-containing modified dry mortar formulation in any standard manner.

For the end-use application, the dry mortar formulation can be mixed with water and applied as wet material. In accordance with the presently disclosed and claimed inventive concept(s), the composition when used in a dry cementitious tile adhesive formulation can be mixed with a sufficient amount of water to produce a cementitious tile adhesive mortar. The water/cement ratio (water factor) can impact strength performance of cement based mortars. High water demand usually decreases strength values like tensile strength. However, the multivalent metal salts can offset the lack in strength performance at high water levels.

The following examples illustrate the presently disclosed and claimed inventive concept(s), parts and percentages being by weight, unless otherwise indicated. Each example is provided by way of explanation of the presently disclosed and claimed inventive concept(s), not limitation of the presently disclosed and claimed inventive concept(s). In fact, it will be apparent to those skilled in the art that various modifications and variations can be made in the presently disclosed and claimed inventive concept(s) without departing from the scope or spirit of the invention. For instance, features illustrated or described as part of one embodiment, can be used on another embodiment to yield a still further embodiment. Thus, it is intended that the presently disclosed and claimed inventive concept(s) covers such modifications and variations as come within the scope of the appended claims and their equivalents.

### EXAMPLES

All examples were conducted in cementitious tile adhesives. The cellulose ether (MHEC), polyacrylamide (PAM) and redispersible powder used in the examples are described as follows.

Analytical data of MHEC Samples Used in Examples

| | |
|---|---|
| % OCH₃ | 26.5-28.5 |
| CH₃CH₂OOH | 8.0-10.0 |
| CH₃[CH₂]₂OOH | 0 |
| Brookfieid viscosity RVT Spindle #6 [mPas], 20 rpm, | 15000 |
| 2% solution | |

### Analytical Data of PAM Samples Used in Examples

| | | |
|---|---|---|
| Viscosity, 0.5% | 4.000 | mPas |
| Degree of anionic charge | 20-40 | wt % |

### Analytical Data of RDP Samples Used in Examples

| Polymer type | VAC/E |
|---|---|
| T_{g} (mid point) | 16° C. |
| MFFT* | 4° C. |

*MFFT = Minimum Film Forming Temperature

### Example 1

### Visual Open Time Improvement Using Al³⁺ Modified RDP

The performance properties were tested using the following cementitious tile adhesive formulation:

| Ingredient | Amount, wt % |
|---|---|
| Cement 52.5 R | 37.50 |
| Sand F35 | 59.15 |
| Calcium formate | 0.40 |
| Redispersible powder (RDP) 4 Multivalent Metal Salt | 2.50 |
| PAM modified MHEC | 0.45 |

The cementitious tile adhesive was prepared, mixed and tested for open time according to ISO13007-2. For open time determination, the ready mixed mortar was applied with a notched trowel (6×6×6 mm) on a fibre cement plate. Every five minutes 5×5 cm earthenware and stoneware tiles were embedded by loading with a 2 kg weight for 30 seconds.

The tile was removed and the backside of the tile was judged. If more than 50% was covered with cementitious tile adhesive, open time was still ok. Open time was finished, if less than 50% was covered with cementitious tile adhesive.

The following RDP samples with or without multivalent metal salt were evaluated.

| Sample | Compositions |
|---|---|
| 1 | VAC/E copolymer |
| 2 | VAC/E copolymer, aluminum hydroxide added during spray |
| | drying process |
| 3 | VAC/E copolymer, aluminum hydroxide post added |

The test results are shown in Tables 1 and 2. As can be seen in Table 1 aluminum hydroxide strongly interacts with polyacrylamide modified cellulose ether in the cementitious tile adhesives. Aluminum hydroxide boosts efficiency of PAM in the dry mortar system significantly. Mortar viscosity strongly increases as well as the resulting water demand. The much higher water demand of the final mortar prolongs the visual open time significantly.

As can be seen in Table 2 aluminum hydroxide was added via two different approaches. During the RDP spray dry process and post added as physical blend. Both combinations generate strong synergistic interaction with PAM modified cellulose ether.

TABLE 1

| | Multivalent | | | | Open | Open |
|---|---|---|---|---|---|---|
| RDP, | Metal | | | | time, | time, |
| VAC/E | Salt | MHEC | PAM | WF* | EW** | SW*** |
| 2.50% | none | 0.423% | 0.027% | 0.32 | 40 | 55 |
| 2.38% | 0.12% | 0.423% | 0.027% | 0.34 | 75 | 85 |
| | Al(OH)₃ | | | | | |

*WF = water factor: amount of used water divided by amount of used cementitious tile adhesive (CTA), e.g. 20 g of water on 100 g of CTA results in a water factor of 0.2.
**EW = earthenware tiles
***SW = stoneware tiles

TABLE 2

| | | | | | Open | Open |
|---|---|---|---|---|---|---|
| RDP, | Aluminum | | | | time, | time, |
| VAC/E | hydroxide | MHEC | PAM | WF | EW | SW |
| 2.500% | none | 0.423% | 0.027% | 0.32 | 40 | 55 |
| 2.375% | 0.125%, | 0.423% | 0.027% | 0.34 | 75 | 85 |
| | post added | | | | | |
| 2.375% | 0.125%, | 0.423% | 0.027% | 0.34 | 45 | 65 |
| | spray dried | | | | | |

### Example 2

### Impact of Al³⁺ Modified RDP on Cement Strength Performance

The performance properties were tested using the following cementitious tile adhesive formulation:

| Ingredient | Amount, wt % |
|---|---|
| Cement 52.5 R | 37.50 |
| Sand F35 | 59.15 |
| Calcium formate | 0.40 |
| Redispersible powder (RDP) + Multivalent Metal Salt | 2.50 |
| PAM modified MHEC | 0.45 |

The cementitious tile adhesive was prepared, mixed and tested for tensile adhesion strength according to ISO13007-2. To test the tensile adhesion strength, the mixed mortar was applied to a slab of concrete with a 6×6×6 mm notched trowel at an angle of 60°. Every five minutes 5×5 cm tiles were embedded by loading with a 2 kg weight for 30 seconds. The measuring of tensile adhesion strength was conducted after the respective storage (dry storage: 7 days and 28 days at 23° C. and 50% relative humidity). The test results are shown in Tables 3 and 4.

As can be seen in Table 3 aluminum hydroxide strongly interacts with polyacrylamide. This interaction results in high water/cement ratio (water factor). High water demand normally decreases tensile strength of cement based cementitious tile adhesive.

Contrary to expectations aluminum hydroxide does offset lack in strength performance at high water levels. Aluminum hydroxide was added via two different approaches—the RDP spray dry process and post added as physical blend. As can be seen in Table 4 both combinations generate strong synergistic interaction with PAM modified cellulose ether, but do not affect tensile strength in a negative way. The experimental error of these tests was +/−0.1 N/mm²

TABLE 3

| | Multi- | | | | Tensile | Tensile |
|---|---|---|---|---|---|---|
| | valent | | | | strength | strength |
| RDP, | Metal | | | | 7 days | 28 days |
| VAC/E | Salts | MHEC | PAM | WF | dry | dry |
| 2.50% | none | 0.423% | 0.027% | 0.32 | 0.9 N/mm² | 0.8 N/mm² |
| 2.38% | 0.12% | 0.423% | 0.027% | 0.34 | 0.9 N/mm² | 0.8 N/mm² |
| | Al | | | | | |
| | (OH)₃ | | | | | |

TABLE 4

| RDP, | Aluminum | | | | Tensile strength | Tensile strength |
|---|---|---|---|---|---|---|
| VAC/E | hydroxide* | MHEC | PAM | WF | 7 days dry | 28 days dry |
| 2.5000% | none | 0.423% | 0.027% | 0.32 | 0.9 N/mm² | 0.8 N/mm² |
| 2.375% | 0.125%, | 0.423% | 0.027% | 0.34 | 0.9 N/mm² | 0.8 N/mm² |
| | post added | | | | | |
| 2.375% | 0.125%, | 0.423% | 0.027% | 0.34 | 0.8 N/mm² | 0.7 N/mm² |
| | spray dried | | | | | |

### Example 3

### Visual Open Time Improvement Using Fe⁺ Modified RDP

The performance properties were tested using the following cementitious tile adhesive formulation:

| Ingredient | Amount, wt % |
|---|---|
| Cement 52.5 R | 37.50 |
| Sand F35 | 58.65 |
| Calcium formate | 0.40 |
| Redispersible powder (RDP) + Multivalent Metal Salt | 3.00 |
| PAM modified MHEC | 0.45 |

The cementitious tile adhesive was prepared, mixed and tested for open time according to ISO13007-2. For open time determination, the ready mixed mortar was applied with a notched trowel (6×6×6 mm) on a fibre cement plate. Every five minutes 5×5 cm earthenware and stoneware tiles were embedded by loading with a 2 kg weight for 30 seconds.

The tile was removed and the backside of the tile was judged. If more than 50% was covered with cementitious tile adhesive, open time was still ok. Open time was finished, if less than 50% was covered with cementitious tile adhesive.

The following RDP samples with or without multivalent metal salt were evaluated.

| Sample | Compositions |
|---|---|
| 1 | VAC/E copolymer |
| 2 | VAC/E copolymer, iron chloride, post added |

The test results are shown in Table 5. As can be seen in Table 5 iron chloride strongly interacts with polyacrylamide modified cellulose ether in the cementitious tile adhesives. Iron chloride boosts the efficiency of PAM in the dry mortar system significantly. Mortar viscosity strongly increases as well as the resulting water demand. The much higher water demand of the final mortar prolongs the visual open time significantly.

TABLE 5

| | | | | | Open | Open |
|---|---|---|---|---|---|---|
| RDP, | Multivalent | | | | time, | time, |
| VAC/E | Metal Salt | MHEC | PAM | WF | EW | SW |
| 2.5% | none | 0.423% | 0.027% | 0.32 | 40 | 55 |
| 2.5% | 0.5% | 0.423% | 0.027% | 0.35 | 50 | 65 |
| | FeCl₃ | | | | | |

It is, of course, not possible to describe every conceivable combination of the components or methodologies for purpose of describing the disclosed information, but one of ordinary skill in the art can recognize that many further combinations and permutations of the disclosed information are possible. Accordingly, the disclosed information is intended to embrace all such alternations, modifications and variations that fall within the spirit and scope of the appended claims.

What is claimed is:

1. A mixture composition for modifying a dry mortar formulation comprising at least one redispersible polymer powder, a polyacrylamide, a cellulose ether, and a multivalent metal salt.

2. The mixture composition of claim 1, wherein the redispersible polymer powder comprises at least one polymer selected from a homopolymer, a copolymer, a terpolymer and combinations thereof.

3. The mixture composition of claim 2, wherein the polymer is obtained from polymerizing one or more monomers selected from the group consisting of vinyl esters of unbranched and branched C₁-C₁₅ akylcarboxylic acids, (meth)acrylic esters of C₁-C₁₅-alcohols, vinylaromatics, olefins, dienes, vinyl halogenides, and combinations thereof.

4. The mixture composition of claim 1, wherein the cellulose ether is selected from the group consisting of alkylcelluloses, hydroxyalkylcellluloses, alkylhydroxyalkylcelluloses, and combinations thereof.

5. The mixture composition of claim 1, wherein the polyacrylamide is selected from the group consisting of polyacrylamide-co-sodium acrylate), polyacrylamide-co-acrylic acid), poly(acrylamide-co-sodium-acrylamido methylpropanesulfonate), poly(acrylamide-co-acrylamido methylpropanesulfonic acid), and combinations thereof.

6. The mixture composition of claim 1, wherein the multivalent metal salt is an aluminum salt.

7. The mixture composition of claim 6, wherein the aluminum salt is selected from the group consisting of aluminum sulfate, aluminum hydroxide, aluminum hydroxysulfate, aluminum halogens, aluminum nitrate, and combinations thereof.

8. The mixture composition of claim 1, wherein the multivalent metal salt is an iron salt.

9. The mixture composition of claim 8, wherein the iron salt is selected from the group consisting of iron sulfate, iron chloride, iron nitrate, iron phosphate, iron acetate, and combinations thereof.

10. The mixture composition of claim 3, wherein the vinyl ester is selected from the group consisting of vinyl acetate, vinyl propionate, vinyl butyrate, vinyl-2-ethylhesanoate, vinyl laurate, 1-methylvinyl acetate, vinyl pivalate, vinyl acetate-ethylene copolymers, vinyl ester-ethylene0vinyl chloride copolymers, vinyl acetate copolymers, vinyl esters of alpha-branched monocarboxylic acids, vinyl acetate-acrylic ester copolymers, and combinations thereof.

11. The mixture composition of claim 3, wherein the (meth)acrylic ester is selected from the group consisting of methyl acrylate, methyl methacrylate, ethyl acrylate, ethyl methacrylate, propyl acrylate, propyl methacrylate, n-butyl acylate, n-butyl methacrylate, 2-ethylhexyl acrylate, copolymers of methyl methacrylate with 1,3-butadiene, and combinations thereof.

12. The mixture composition of claim 2, wherein the redispersible polymer is a vinyl acetate/ethylene polymer.

13. The [mixture composition of claim 4, wherein the cellulose ether is alkylhydroxyalkylcellulose.

14. The mixture composition of claim 13, wherein the alkylhydroxyalkylcellulose is methylhydroxyethylcellulose or methyihydroxypropylcellulose.

15. A modified dry mortar formulation comprising hydraulic cement, fine aggregate material, a cellulose ether, a polyacrylamide, a redispersible polymer powder, and a multivalent metal salt.

16. The modified dry mortar formulation of claim 15, wherein the multivalent salt is an aluminum salt.

17. The modified dry mortar formulation of claim 16, wherein the aluminum salt is selected from the group consisting of aluminum sulfate, aluminum hydroxide, aluminum hydroxysulfate, aluminum halogens, aluminum nitrate and combinations thereof.

18. The modified dry mortar formulation of claim 15, wherein the multivalent salt is an iron salt.

19. A modified dry mortar formulation comprising a standard dry mortar formulation, a cellulose ether, a polyacrylamide, a redispersible polymer powder, and a multivalent metal salt.

20. A method for making a modified dry mortar formulation comprising the steps of:
mixing the mixture composition of claim 1 to a dry mortar; and
admixing the amount of water required for processing to a settable mortar,
and optionally adding further individual components subsequently to the preparation of the water-containing settable mortar.
